(19) United States
(12) Patent Application Publication
(10) Pub. No.: US 2016/0335905 A1
(43) Pub. Date: Nov. 17, 2016

(54) SYSTEMS FOR QUANTITATIVE LEARNING THAT INCORPORATE USER TASKS IN THE WORKPLACE

(71) Applicant: Jubi, Inc., Alpharetta, GA (US)

(72) Inventors: Terry Barber, Alpharetta, GA (US); Lawrence Mohl, Milton, GA (US)

(21) Appl. No.: 15/152,505

(22) Filed: May 11, 2016

Related U.S. Application Data
(60) Provisional application No. 62/159,954, filed on May 11, 2015.

(51) Int. Cl. G09B 7/00; G09B 5/02; G06Q 10/06

(52) U.S. Cl. CPC G09B 7/00; G06Q 10/06; G09B 5/02

(57) ABSTRACT

Systems and methods are presented herein for facilitating impactful learning in a corporate environment. The system may include a server that communicates with computing devices, allowing users to access and participate in a learning hierarchy of programs, levels, quests, challenges, and participation items. Users may incorporate actual work tasks into the learning environment, and author new quests that other users participate in. Challenges, tasks, collaboration, and encouragement may be scored to gamify the learning and working experience.

### CROSS REFERENCE TO RELATED APPLICATION

This application claims priority to provisional patent application No. 62/159,954 (“Systems for Quantitative Learning That Incorporate User Tasks in the Workplace”), filed May 11, 2015, which is incorporated herein by reference in its entirety.

### DESCRIPTION OF THE EMBODIMENTS

1. Field of the Embodiments

The embodiments relate generally to systems for quantitative learning, and more specifically, to systems for quantitative learning in a corporate environment that integrate performance of actual work tasks into the learning experience.

2. Background

Corporations spend billions of dollars per year training their workforces. Most of the time, this includes providing a guest speaker or a video program that the employee watches from their desk, and the employee indicates their attendance but generally does little more to complete the training. This sort of consumption of media generally does not result in impactful learning. Instead, many employees fail to truly engage with such corporate learning programs, which can lead to them learning less than desired and wasting time in training that could otherwise be spent working. Because guest speakers (live or recorded) can be costly and only provide limited interaction with the company's entire workforce, programmatic training solutions that provide ongoing training are needed.

Additionally, there is no reliable way for an enterprise to determine if its training programs are effective. Current solutions provide little insight into the translation of user learning into actual performance on the job. The teaching effectiveness of current systems is measured qualitatively rather than quantitatively.

Current programmatic teaching systems are unable to deeply impact work performance in part because current teaching techniques would require custom programming and specially-created training materials for each particular job in a company. Said another way, because corporate training programs are often created for and sold to a wide variety of companies, the training software does not apply to job-specific tasks. Content, such as videos, must instead be directed to a wide audience to ensure that the training system will be used be enough companies to make the system economically viable. Because training modules are largely genericized, they may also be ineffective with certain groups of employees.

Therefore, a need exists for computer-based learning systems that can be more easily tailored to particular enterprises or users within those enterprises, and specifically for teaching systems that incorporate work tasks into the training.

### SUMMARY

Embodiments described herein include systems and methods for gamifying learning in a workplace environment. These systems and methods may include a system for gamified learning that includes a database that stores content for presentation in a learning environment, and a processor in communication with the database. The processor and database may be part of a server that communicates with users of various computing devices, presenting a gamified learning environment on the computing devices. The learning environment may utilize a teaching hierarchy that includes at least one program, a first level within the program, and at least a first quest within the first level. Typically there will be multiple programs, and within each program multiple levels, and within each level multiple quests.

A quest may include media content that plays while a challenge is simultaneously presented to the first user in the form of a question. For example, images, audio, or video may play in a first frame while a text question and potential answers are simultaneously presented in another frame. Each quest may include multiple challenges, each of which is scored based on user answers and/or time to complete the challenge.

Additionally, the quest may include a performance item (i.e., a “do item” or a “to-do item”), that requires the user to apply in the workplace some aspect of what is being taught. Because such performance item(s) may not have the same kind of right or wrong answer as a test question, completion of the performance item(s) may be validated by a second user of the system, such as the first user's manager or a peer that has already completed the quest.

The performance item(s) may be scored in addition to the challenge item(s) as part of calculating a user score for a quest. Based on scores from completed challenges and performance items and points awarded for encouragement and collaboration, other levels or quests may be unlocked. In this way, a user may navigate the learning process non-linearly in an embodiment to best suit their particular learning aptitudes, and points may be awarded for behaviors that are encouraged in the workplace, gamifying the learning environment and integrating it with day-to-day work activities. The user may also create new quests in one embodiment, making the learning environment self-sustaining.

In an embodiment, the system may also determine which quests are relatively more effective than others, such as through a combination of user reviews, and relative completion statistics for challenges and performance items. The system may graphically orient the more effective quests above less effective quests.

Additionally, key performance indicators (“KPIs”) for the enterprise can be assigned to Do Items. For example, an enterprise could have ten different KPIs. A Do Item can have a plurality of KPIs assigned to it. If the Do Items are being completed successfully and enterprise performance is increasing relative to the KPIs, then the quests and Do Items can be validated as successful. However, if the Do Items are completed successfully and enterprise performance does not improve or decreases relative to the KPIs, then the quests and Do Items can be vetted as ineffective. In the later instance, the quests and Do Items can be changed or replaced until enterprise performance around the KPIs tracks the number of successfully completed Do Items. Do Items are alternatively referred to as To Do items and performance items.

Example KPIs can include customer conversion rates, cost of customer acquisitions, click through rate, or any other important metric, which can vary from industry to industry or enterprise to enterprise.

It is to be understood that both the foregoing general description and the following detailed description are exemplary and explanatory only and are not restrictive of the embodiments, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is an exemplary diagram of a system, in accordance with an embodiment;

FIG. 2 is an exemplary illustration of a schema used in a system, in accordance with an embodiment;

FIG. 3 is an exemplary flow chart for a quest, in accordance with an embodiment;

FIG. 4 is an exemplary flow chart for scoring, in accordance with an embodiment;

FIG. 5 is an exemplary flow chart for authoring a quest, in accordance with an embodiment;

FIG. 6 is an exemplary diagram for authoring a program, in accordance with an embodiment;

FIG. 7 is an exemplary flow chart for GUI presentation, in accordance with an embodiment;

FIG. 8 is an exemplary diagram of system components, in accordance with an embodiment;

FIG. 9 is an exemplary diagram of a GUI dashboard, in accordance with an embodiment;

FIG. 10 is an exemplary diagram of a GUI used by an administrator to assess group performance, in accordance with an embodiment; and

FIG. 11 an exemplary diagram of a GUI in an authoring tool in accordance with an embodiment.

### DESCRIPTION OF THE EMBODIMENTS

Reference will now be made in detail to the present exemplary embodiments, including examples illustrated in the accompanying drawings. Wherever possible, the same reference numbers will be used throughout the drawings to refer to the same or like parts.

In one embodiment, a system may allow a user to participate in a gamified learning environment. The system may include a server that users may connect to over a network, such as the Internet. The users may participate in the learning environment through interacting in a series of programs, levels, and quests, with the system tracking the user's process by storing user quest progress, scores, activities, content contributions, user profile content, social networking aspects, and other attributes of the user's experience.

The system may utilize a performance algorithm that incorporates learning, doing, and inspiring in scoring a user. This encourages impactful learning that actually transcends into performance within the workplace.

To this end, unlike existing systems for corporate training, an embodiment herein may incorporate performance items (i.e., “do items”) into the training that require a user to actually implement something learned in the quest in their day-to-day job. The performance item may be completed by submission of graphical evidence in one embodiment, or by verification from a peer user, such as a user's manager. The performance items may also serve as criteria in the user's internal review process at the company where they work.

Prior corporate learning systems focus on presenting content to users in a manner that will hold the user's attention. Such systems are qualitative in nature. By contrast, an embodiment herein combines gamifying elements with actual on-the-job implementation to ensure that the training leads to an impact in the user's actual job functions, and, therefore, is a quantitative and measurable training tool.

Regarding the inspiration component, the system may also facilitate collaboration and encouragement between users, instilling and rewarding the correct value system within the company. Users may accumulate points by completing quests (including challenges and do items), encouraging and collaborating with others in their quests, and by contributing new quests. Thus, positive aspects of the user (e.g., employee) may be recognized by viewing a scoreboard and more easily rewarded within the company.

Thus, in addition to rewarding learning and doing, the system may reward user inspiration behaviors such as encouraging, appreciating, sharing stories, asking question, and coaching in the context of social interaction. The system may also have algorithms such as a learning transfer index and an inspiration index that work to continually learn about a user's behavior and stimulate them to maximize their performance and shape the environment for others. Users may maximize their score by creating a balance between earning points and rewards in all three areas: LEARN, DO, INSPIRE, which may result in predictable performance improvement. This proactive shaping of user behavior to learn, do, and inspire requires the collection and analysis of specific user behaviors while engaged in a program as well as algorithms designed to amplify or modify user behaviors as they work through a program. Inspiration can include activities such as encouragement, appreciation, storytelling, and holding another user accountable.

The system may further include an authoring tool that allows users to generate custom quests for their peers. The authoring tool may allow a user to create at least one challenge, and link media content (e.g., images, audio, or video) to the challenge(s), and associate one or more do items with the challenge. When other users participate in these quests, the system may award points to the creating user. This creates a cycle where employees contribute to the training of other employees and are rewarded for doing so.

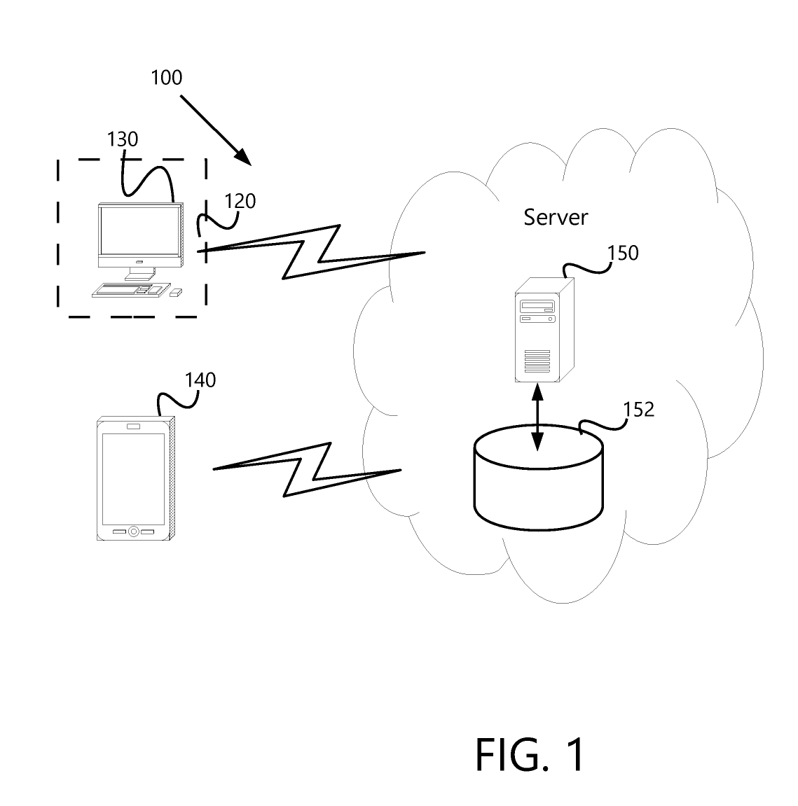

Turning to FIG. 1, an exemplary system 100 is illustrated in accordance with an embodiment. The system may include a server 150 and a database 152 that may communicate with a plurality of users. The users may utilize computing devices 130 and 140 to communicate with the server over a network, such as a cellular network or the Internet. In another embodiment, the network is an intranet network.

The computing device can be a cell phone 140, smart phone, tablet, laptop, personal computer 130, or television. In another embodiment, the computing device 120 is a virtual reality headset, or wearable screen that presents images in front of the user's eyes. Other examples of computing device 120 include any portable or non-portable, processor- or controller-based device. Additional example computing devices 120 are discussed below, and any device capable of displaying the content discussed herein is contemplated.

The computing device 120 may display a dashboard to the user through which the user is able to participate in the system's 100 learning environment. The user may, for example, select programs, levels within programs, quests within levels, and/or challenges or participation items within quests. The user may generally complete quests by first navigating the content and correctly answering questions related to the content.

In addition, the user may need to complete one or more participation items to complete the quest. In one embodiment, the computing device 120 acts as a receiver for the evidence of completion of participation items by a first user, such as through video, photo, or audio capture. The computing device 120 may submit the evidence to the server 150, which may in turn store the evidence in database 152 for review by a second employee, such as the first employee's manager. Unlike software solutions that merely provide for annual or quarterly employee reviews, an embodiment herein may provide for a rolling review based on ongoing managerial input regarding completion of the various participation items (i.e., do items). This may provide for a more accurate assessment of the employee over the course of an entire year, rather than a manager trying to recount aspects of the employee's performance long after particular tasks were performed.

The server 150 may also store user profile information and historical performance data in a database 152 in one embodiment.

The server 150 may also analyze user profile data and quests completed to recommend additional programs or quests to the user. For example, if the user profile indicates that the user is a software developer and the completed quests have involved learning about various components of the company's backend system, additional quests relating to different backend component functionality may be recommended to the user. This may allow the user to efficiently learn about aspects of the company directly relevant to his or her job and in alignment with his or her interests. In turn, management may be alerted regarding particular interests of the user within the company based on quest completion history, which may assist management with delegating future tasks to the user that are aligned with the user's interests and expanding knowledge base.

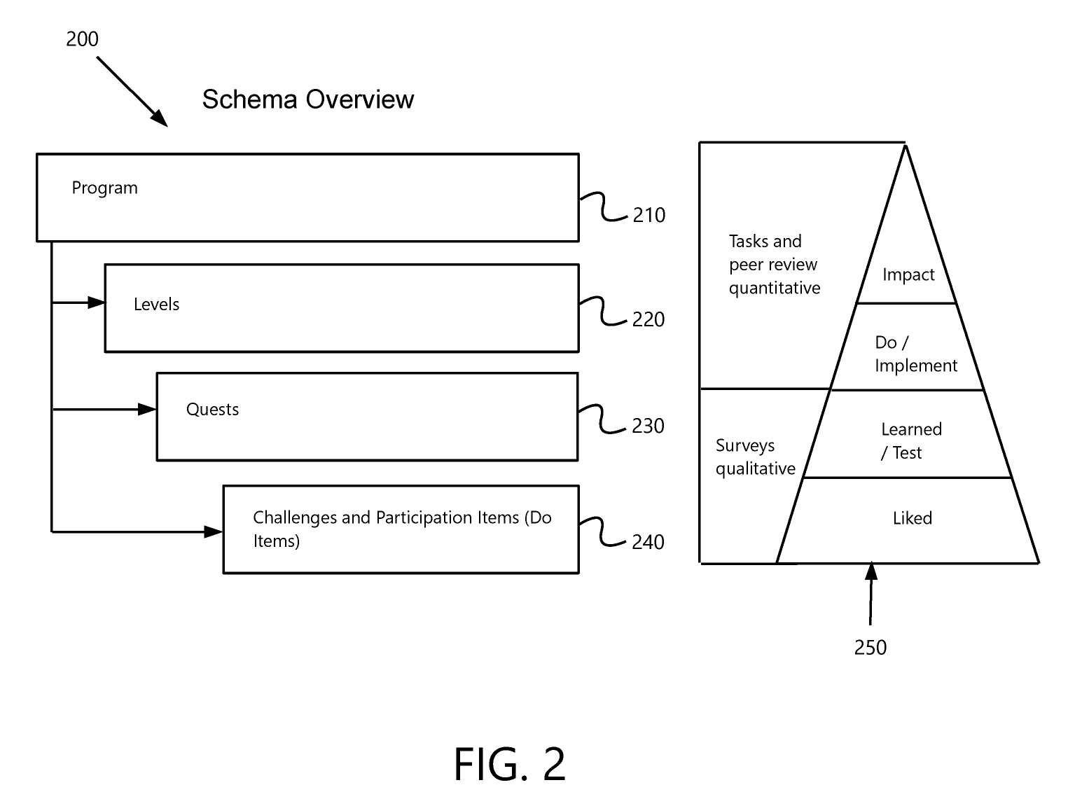

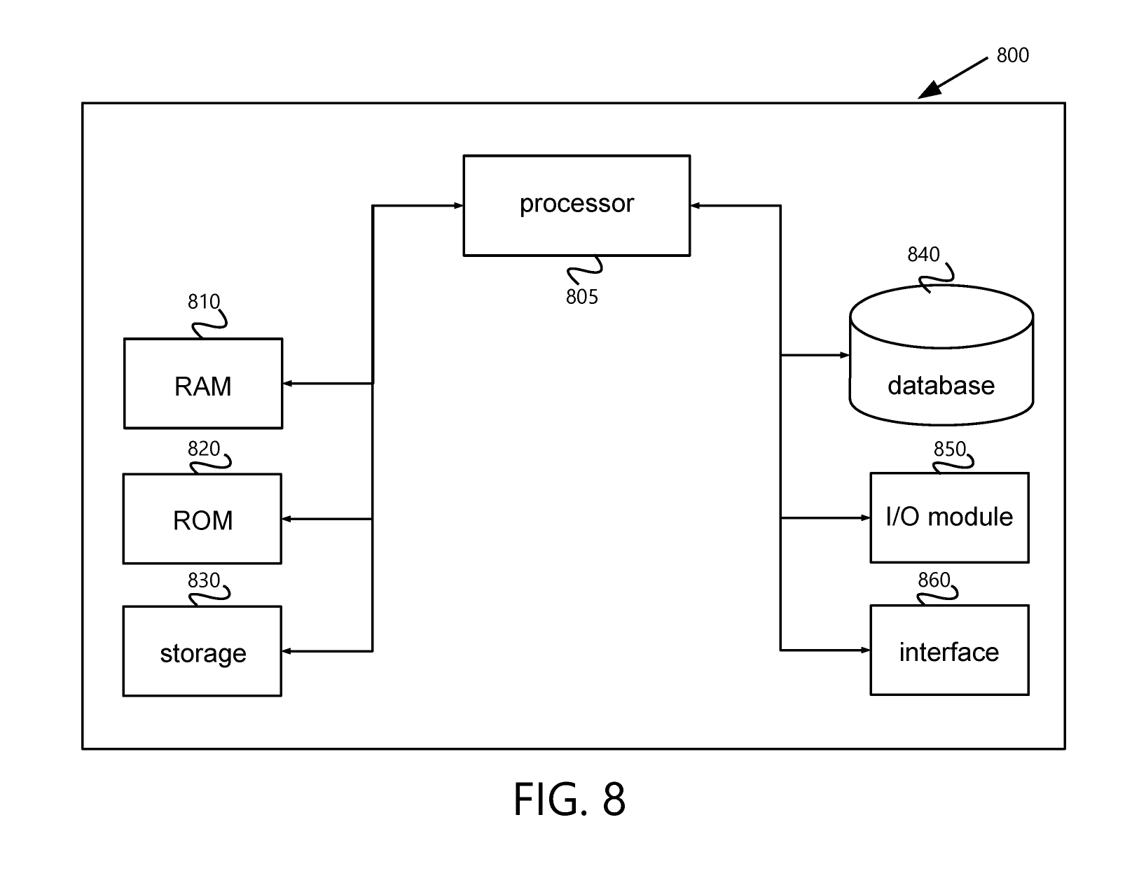

Turning to FIG. 2, an example schema 200 is illustrated. This schema is provided for example purposes, and actual embodiments may have more detailed schemas (such as described with respect to FIG. 8). As shown in FIG. 2, the learning system may present learning materials in a hierarchical format, with a program 210 having one or more levels 220, which in turn have one or more quests 230, which in turn have on ore more challenges or participation items 240. Whereas a program may broadly focus the subject matter, levels and quests may more narrowly focus the subject matter.

As used in an embodiment herein, a quest may represent a format of content learning that is more immersive and impactful than formats provided by existing learning systems. First, rather than simply playing a media file and following that with a test, the quest may simultaneously display at least one challenge while the media file is playing. This may allow a user to be critically thinking while the media is playing, and more engaged in the learning process.

Second, rather than just asking the user to answer questions about what was taught in the content, a quest may include a participation item (i.e., a do item). As used herein, a participation item may require action by the user in his or her work capacity, rather than simply providing an electronic response in the challenge module.

As an example, a company may train one of its IT employees by providing a program about database optimization. One of the quests in the program may focus on applying proper indexing in table columns. In addition to asking the user to answer one or more questions related to this optimization, the quest may contain a participation item that requires the user to locate at least one table in the company's database that is not properly indexed and create an optimal index structure. To verify that this “do item” has been completed, in one embodiment the system will receive input from a second user that is associated with the first user, such as in a managerial capacity.

In another embodiment, verification of completion of the participation item may be provided by peer review. For example, the first user may be prompted to paste in a snippet of SQL code representative of the corrective indexing performed. The system may determine other peer users to review the submission based on scores of the peers in combination with having a profile also indicating IT background or direct working relationship with the first user. The peer users may be prompted by the system, such as during a quest, to answer whether or not the first user's code would correctly index the table. If the peer users answer affirmatively, then the system would credit points to the first user and the peer users (for collaboration), and notify the first user that the participation item is complete.

The system may also notify the first user of which peer users verified or did not verify completeness. If a peer user does not believe the participation item is complete, the system may facilitate a communication channel between the first user and the peer user to collaborate on determining the correct solution. Based on the collaboration, both users may be awarded points. The points may be based on a rating given by a peer user or aggregated across multiple peer users that verified the solution. This may allow the system 100 to score diverse actions that may be taken in response to a participation item, whereas a typical learning system would have no way of determining if the response was adequate or how many points should be awarded.

Additionally, in one embodiment, the system 100 may prompt the user and peer user to collaborate on a new quest that further clarifies the subject matter if the system counts a threshold number of collaborative messages between the users. The additional quest may be added to the hierarchy 200 as discussed in more detail herein.

Thus, the participation item may encourage or even require actual participation between employees on real work tasks as part of the training. The synergistic effect of challenges simultaneous with the training media, coupled with participation items and collaboration, can cause the learning experience to change from qualitative to quantitative.

This concept is illustrated in the learning pyramid 250. Whereas typical learning systems may accomplish the first two levels of pyramid 250, it is difficult to tell whether the educational material is truly beneficial when all the system knows is that users are watching and have answered a few questions. But when the users begin implementing the learning by actually doing work tasks that are peer reviewed and scored accordingly, then the educational experience may become quantitative and much more objectively measured.

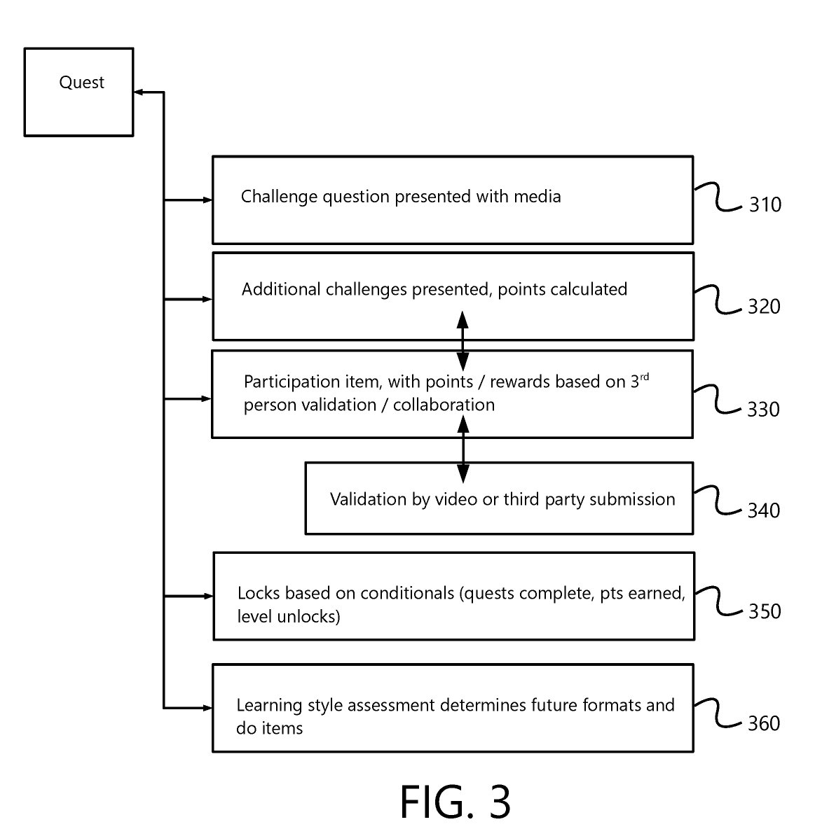

FIG. 3 is an exemplary flowchart of steps that illustrate how users participate in quests in a system herein. First, at step 310 a question may be presented with media. In one embodiment, this includes playing media (e.g., video, audio, images) in a first frame while a second frame contains a question. In another embodiment, the question is superimposed over the media, such as in the foreground of the dashboard screen. The question may have potential answers displayed with it in one embodiment. In another embodiment, the answers do not immediately appear.

At step 320, additional challenges may be presented to a user. For example, each time a user answers correctly, the subsequent challenge may be presented. Points may be awarded based on correctness and time taken to answer. In one embodiment, new challenges are synchronized to appear on screen as the media progresses to portions relevant to that challenge.

At step 330, the user is presented with a participation item. The participation item may ask the user to use the skill in the work context, and may give an indication of who may verify that the participation item is complete. At this point, the participation item may post on the user's dashboard separate from the quest, so that even when the user leaves the quest he or she will be reminded of the need to complete the participation item and be able to open the participation item to re-read the instructions or to submit a response, such as a video file or, as was the case in the example discussed with respect to FIG. 2, by submitting work product in response to the participation item. In another embodiment, the first user simply indicates that the participation item is complete (and, for example, may provide a brief description of what the first user did to complete the task), and the system will then flag the participation item for verification.

At step 340, the system will verify the user's completion of the participation item through inputs by at least one third party, as discussed previously. This may be accomplished by a manager in one embodiment. The system may send an alert, such as an email, to the manager to notify them that the first user's actions need verification. The manager may log into the system to verify and/or rate the first user's completion of the participation item.

At step 350, the system may adjust locks based on user points. The points may increase each time a user completes a quest, including challenges and/or participation items. However, in one embodiment, the system may also decrease points if the user passes a threshold amount of time without completing a quest, creating a quest, or collaborating with other users who in their own quests.

In one embodiment, the locking and unlocking of quests is performed serially. For example, when a first quest is completed, the next quest in the same level may unlock. When the entire level is completed, the first quest in the next level may unlock.

In another embodiment, the unlocking may occur in parallel. For example, a quest in a second level may unlock before a quest in a first level based on a relevant participation item being completed by the user in a different quest. Whereas one program might feature parallel unlocking, a second program may feature serial unlocking.

The system may likewise only unlock certain programs based on user credentials in their profile (e.g., applicable job title or management level) or based on accruing enough points in beginner-level programs and quests.

In one embodiment, at step 360, the system performs analysis of user learning. For example, the system may determine the types of questions the user tends to get right and the types of questions the user tends to answer incorrectly. The system may also determine subject matter commonalities for the quests that the user has completed, which may indicate a subject matter interest on the part of the user, particularly in embodiments where the user is able to unlock quests in parallel or where few locks exist to restrict the user's choice of quests. The system may also attempt to match these subject matter findings with attributes in the user's profile in one embodiment.

Based on these findings, the system may reshuffle the presentation of potential quests so that quests of related subject matter and question types are presented in view on the dashboard without additional scrolling required by the user.

The system may also make work recommendations to supervisors of the user. For example, if the system recognizes that a user with a software engineer profile is completing and scoring well on a high number of management-related quests, the system may notify a supervisor that the employee is doing well in areas that appear to be an expansion of their profiled skill set. This may allow supervisors to better gauge which employees may thrive with new responsibilities based on alignment with apparent interests.

Supervisors may also gain insight into employee growth based on the employee's position on the scoreboard.

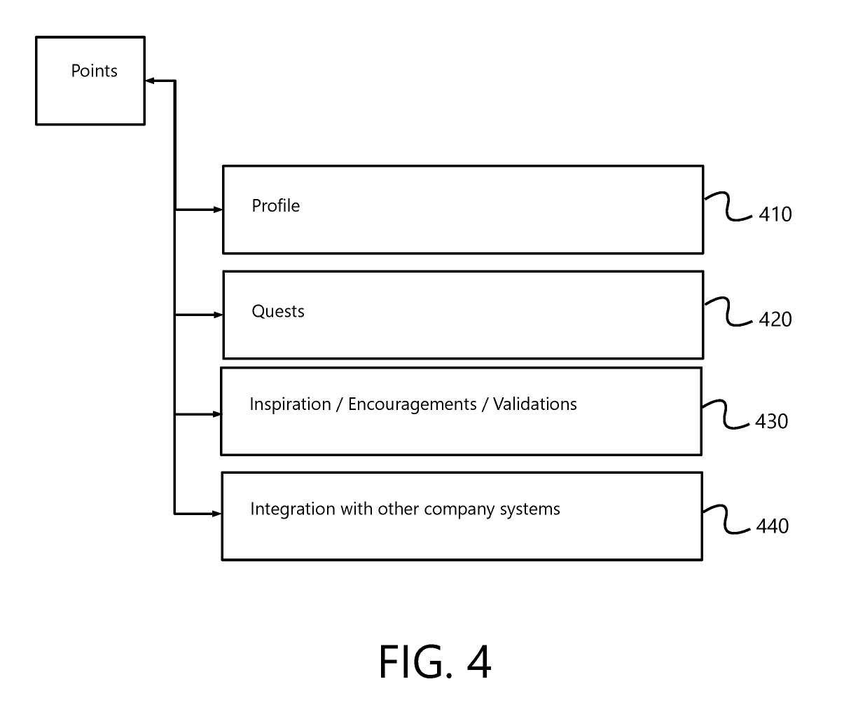

FIG. 4 is an exemplary block diagram indicative of how the system awards points to a user in an embodiment. At step 410, the user may receive points for completing their profile. A detailed profile may help the system use the profile to determine logical peer reviewers and for recommending relevant programs and quests. In one embodiment, a completed profile may result in the system assigning a multiplier to points earned thereafter by the user.

At step 420, the system may award the user points for completing quests. The system may award points separately for challenges and participation items in one embodiment. In another embodiment, the system may award extra points when all items in a particular quest are complete. This may include special points, such as gems, that may be used, for example, to unlock particular quests or levels.

The system may also give points at step 430 when a user encourages another user (such as by commenting on a user's question associated with a challenge or participation item) or validates another user's completion of a participation item in an embodiment.

Further, at step 440, the system may award points when the user uses other company tools or systems to perform quest-related tasks. For example, in a law firm context, the firm's intranet may notify the system when a user uses an online treatise to look for case law. The system may reward this behavior to encourage the user to become familiar with the various resources available at the law firm.

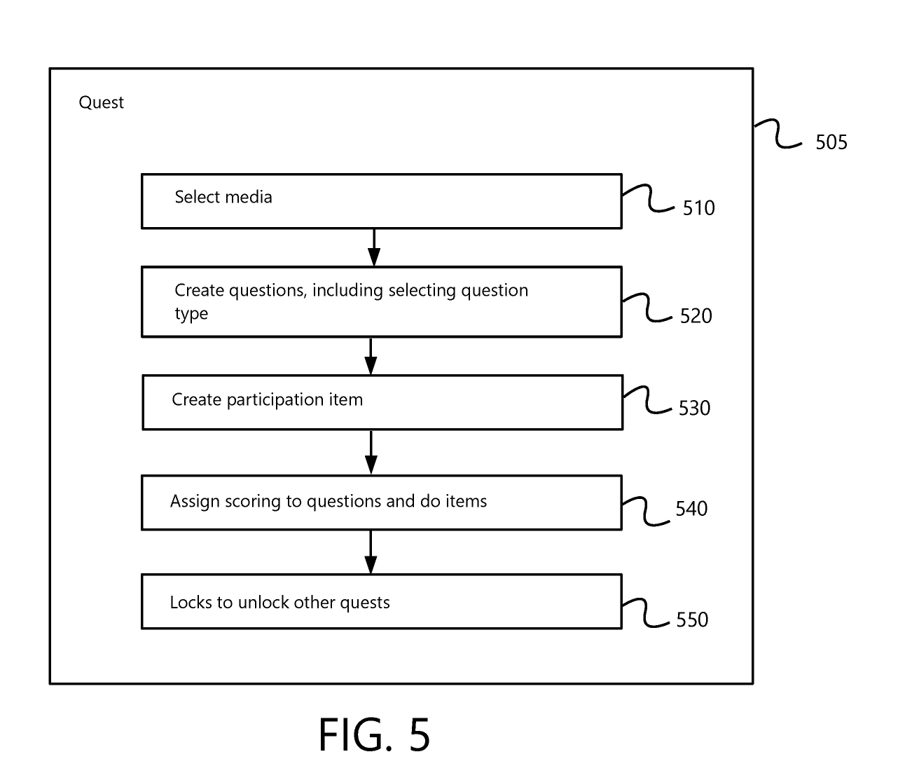

FIG. 5 is an exemplary flow chart associated with authoring a new quest 505 in one embodiment. This may require particular credentials in the user profile in one embodiment. In another embodiment, once a user has earned a threshold level of points from participating in the system, the user is allowed to create quests. By granting users the ability to easily create quests, a company's workforce may begin actually training itself, unlike prior art learning systems that rely solely on newly-purchased programs that may not be specifically tailored to the company and particular jobs within the company.

At step 510, the user may select a media file, which could be a video clip on the Internet or on a local drive. The user can generally select any media that the user feels may help them drive home the educational point of the quest 505.

At step 520, the user may create one or more questions that will be associated with the media clip. This may include selecting a question type (e.g., multiple choice, free text, true or false, among others) and indicating the correct answer(s). For multiple choice questions, the system may randomize the answer presentation. Additionally, the user may specify a time allowed to answer particular questions, for example, if the media clip moves on to other topics that have other associated questions that the user will need to focus on.

At step 530, the user may create a participation item. This may involve typing a description of the task, and assigning verification users or user credentials. This will help determine who the system selects to verify another user's completion of the task.

At step 540, the user assigns point values to various aspects of the quest 505, including challenge(s), participation item(s), collaboration, verification, and 100% quest completion.

At step 550, the user may assign locks for the quest 505. For example, if the user creates the quest in response to another quest that the user felt could use additional detail and clarification, the user may assign a lock to the new quest that requires the original quest to be completed or at least started first. Alternatively or in addition, the user may set a point threshold required to unlock the quest 505.

In another embodiment, the system may include a pre-programmed set of learning sequence templates from which a user may create a program and/or one or more quests. Each template may include a specific order of challenges in a quest designed to execute a specific learning objective based on specific learning types. The learning sequences may represent best-practices in learning design and serve to ensure a high quality experience even with less experienced program authors.

Different learning objectives may include: learning why something is important; learning about something (i.e., what it is or what it means); and learning how to do something. In this way, a template for teaching what something is may be different than a template for learning how to do something, and different challenge sequences may be beneficial for teaching those different objectives.

Similarly, the template may be different for different learning types. For example, different learning types may include conceptual learning, declarative learning, associative learning, or sequential step learning. The challenge sequences for each learning type may differ.

Therefore, by selecting a learning objective and at least one learning type, the system may present the user with one or more template in an embodiment. These templates may pre-populate quests to give the author (i.e., user) a head start on their program or quest design.

The system may analyze which types of learning objectives and learning types are most effective within a program in one embodiment. Based on this analysis, the system may further recommend templates geared towards the most effective learning objectives and types for future quests that are added by a user.

In one embodiment, program design effectiveness is calculated based on measured brain trigger and processing characteristics. Different parts of the human brain may be triggered by certain stimulus and be used to process different types of information. Thus, the templates may leverage the human brain's natural processes to increase the effectiveness of the experience and drive engagement and behavior change. In an embodiment, the system may provide indicators about how the design leverages brain science and/or tips for improvement.

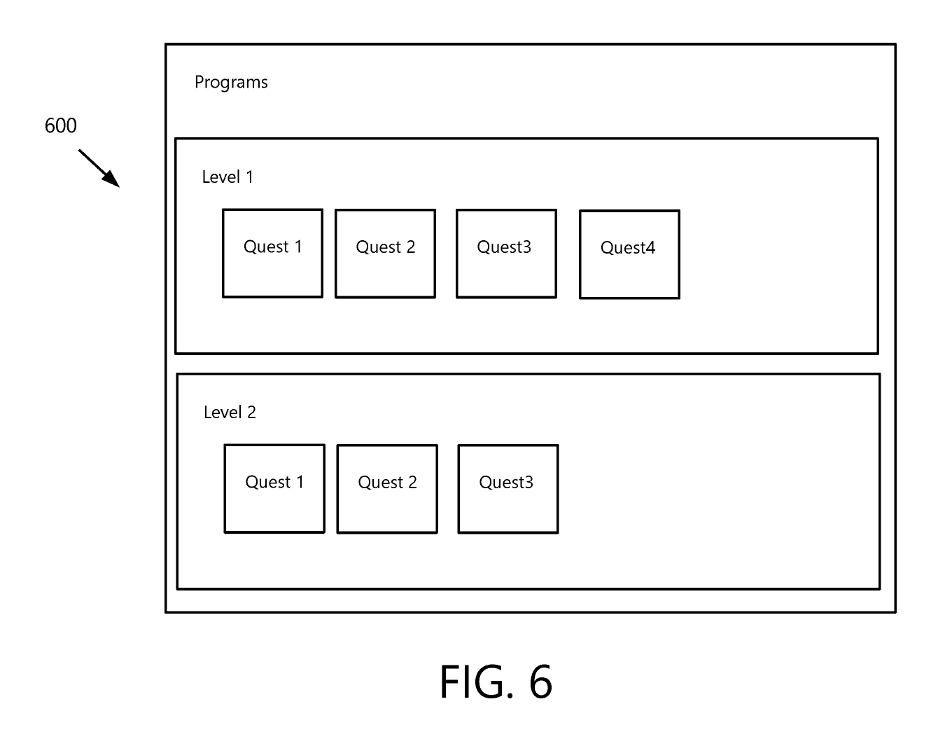

FIG. 6 is an exemplary diagram of a graphical user interface (GUI) 600 that may be displayed on computing devices in accordance with an embodiment. As shown, the GUI 600 (i.e., dashboard) may display one or more program options towards the top of the screen in one embodiment. For the currently selected program, a plurality of levels may be displayed in the form of rows of tiles, wherein each row is a new level. The tiles in each level may represent the respective quests. In this example, level one includes four quests, whereas level two includes three quests.

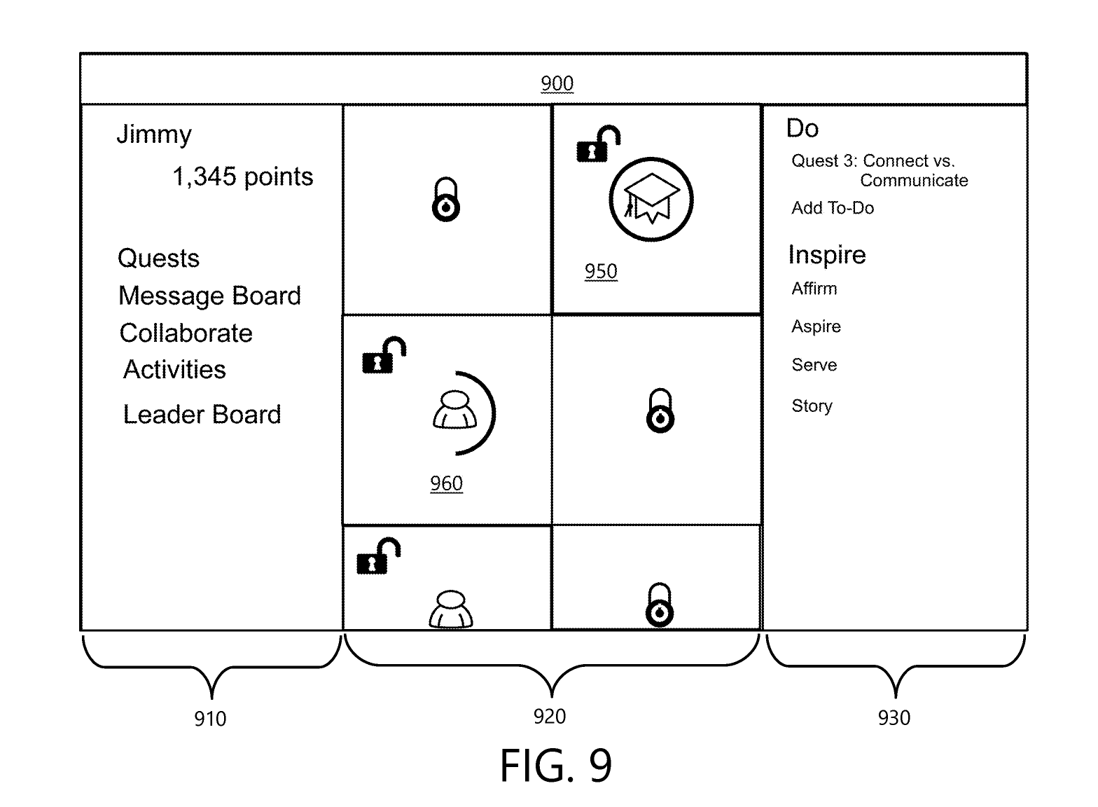

Another example GUI 900 is shown in FIG. 9. As shown, a first panel 910 can include user attributes, such as the name of the user and the user's current score. An indicator of the user's current progress in a level may also be displayed. In this example, the user “Jimmy” has 1,345 points. The first panel 910 can also include links to quests, the message board, collaboration platform, activities, and the leader board.

The quests may include icons that represent the completeness of the quest. For example, a complete circle may indicate full completion, whereas two thirds of a circle may indicate that the quest is only two-thirds complete. In the illustrated example, the quests are included in a second pane 920. A first quest 950 is fully complete, shown by the full circle, whereas a second quest 960 is only half complete, based on the half circle.

The quests may further include lock icons that indicate the quest is locked and not yet available to the user. In one embodiment, the user may click on the lock and receive a tool tip that explains the requirements to unlock that quest.

In addition to the levels and quests, the user's “do items” (i.e., participation items) may be displayed on the right portion 930 of the screen. This may serve as a reminder to the user of the various concepts the user must apply in the course of their work. In one embodiment, if a participation item remains open for too long, the server may begin deducting points from the points earned in the quest to which the participation item belongs.

Other tabs may indicate various users that the user may be able to encourage, such as other users working on quests that the user has already completed. This may help lead to constructive interaction between employees. Similarly, the user may be presented with validation tasks for which they need to validate other users' attempts at various performance items.

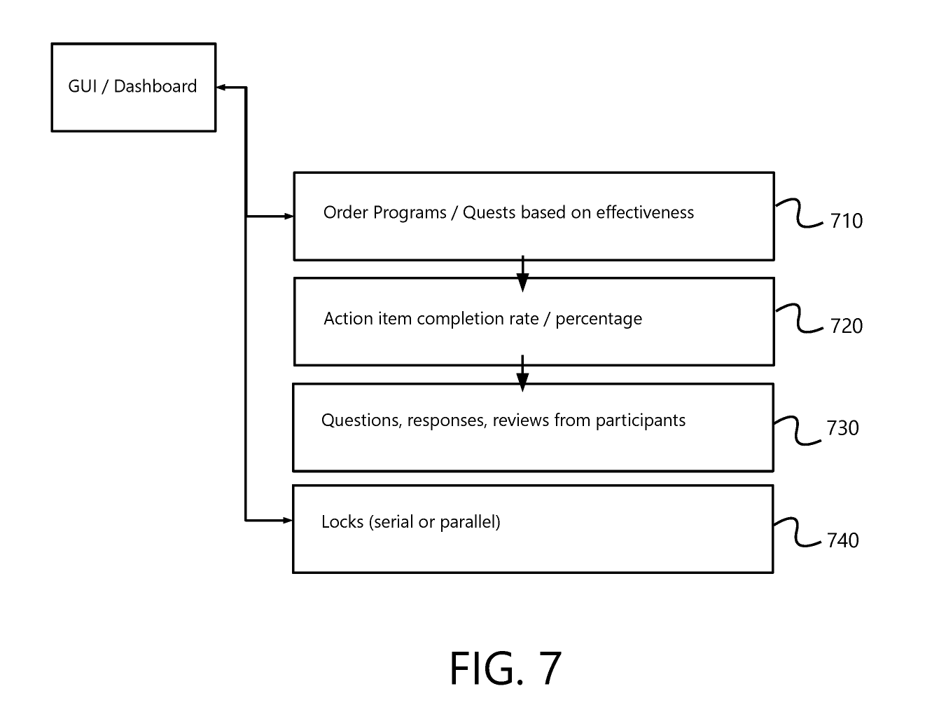

FIG. 7 includes an exemplary flow chart of stages performed by the system in arranging quests on a user's GUI. At step 710, the system may order programs and quests based on effectiveness of those quests and programs. The system may determine effectiveness, for example, by analyzing how long the quest has been available versus the number of action items (e.g., challenges and participation items) users have completed at step 720. If the completeness-to-time threshold is high, then the quest may be elevated to feature more prominently in a user's GUI. Conversely, if not much completion occurs over a long time frame, the quest tile may be pushed off screen such that the user must scroll the GUI to find it.

Similarly, at step 730, the system may consider questionnaires, responses, and reviews from participants in determining which quests to display prominently. The system may also more heavily weight the responses of users with similar profiles to the user.

Additionally, at step 740, the GUI may display newly unlocked quests more prominently. This may also involve shuffling the display of levels such that unlocked levels rise above locked levels in the GUI.

FIG. 8 depicts an exemplary processor-based computing system 800 representative of the type of computing system that may be present in or used in conjunction with communication device 120 and/or server 150 shown in FIG. 1. The computing system 800 is exemplary only and does not exclude the possibility of another processor- or controller-based system being used in or with one of the aforementioned components.

In one aspect, system 800 may include one or more hardware and/or software components configured to execute software programs, such as software for storing, processing, and analyzing data. For example, system 800 may include one or more hardware components such as, for example, processor 805, a random access memory (RAM) module 810, a read-only memory (ROM) module 820, a storage system 830, a database 840, one or more input/output (I/O) modules 850, and an interface module 860. Alternatively and/or additionally, system 800 may include one or more software components such as, for example, a computer-readable medium including computer-executable instructions for performing methods consistent with certain disclosed embodiments. It is contemplated that one or more of the hardware components listed above may be implemented using software. For example, storage 830 may include a software partition associated with one or more other hardware components of system 800. System 800 may include additional, fewer, and/or different components than those listed above. It is understood that the components listed above are exemplary only and not intended to be limiting.

Processor 805 may include one or more processors, each configured to execute instructions and process data to perform one or more functions associated with system 800. The term “processor,” as generally used herein, refers to any logic processing unit, such as one or more central processing units (CPUs), digital signal processors (DSPs), application specific integrated circuits (ASICs), field programmable gate arrays (FPGAs), and similar devices. As illustrated in FIG. 4, processor 805 may be communicatively coupled to RAM 810, ROM 820, storage 830, database 840, I/O module 850, and interface module 860. Processor 805 may be configured to execute sequences of computer program instructions to perform various processes, which will be described in detail below. The computer program instructions may be loaded into RAM for execution by processor 805.

RAM 810 and ROM 820 may each include one or more devices for storing information associated with an operation of system 800 and/or processor 805. For example, ROM 820 may include a memory device configured to access and store information associated with system 800, including information for identifying, initializing, and monitoring the operation of one or more components and subsystems of system 800. RAM 810 may include a memory device for storing data associated with one or more operations of processor 805. For example, ROM 820 may load instructions into RAM 810 for execution by processor 805.

Storage 830 may include any type of storage device configured to store information that processor 805 may need to perform processes consistent with the disclosed embodiments.

Database 840 may include one or more software and/or hardware components that cooperate to store, organize, sort, filter, and/or arrange data used by system 800 and/or processor 805. For example, database 840 may include information to that tracks user information, challenge completion, participation item completion, scores, collaboration and encouragement, quest creation information, and more. Alternatively, database 840 may store additional and/or different information. Database 840 may also contain a plurality of databases that are communicatively coupled to one another and/or processor 805, of may connect to further database over the network.

In one embodiment, the database 840 implements a schema of tables for the learning hierarchy utilized by the system. For example, a program table may include a Program ID field, along with fields with information about the program, such as the name of the program, the goals of the program, the program creator, and more. A Level table may include a Level ID field, along with a Program ID field to link the level to a particular program. Similarly, a Quest table may include a Quest ID field and a level ID field to link the quest to a level. A Challenge table may have a ChallengeID field, a Content field to identify the content that is part of the challenge, and a Question field to identify the question that is part of the challenge.

In one embodiment a QuestToChallenge table may contain both QuestID and ChallengeID fields, linking multiple challenges to a single quest. Similarly, a ChallengeToQuestion table may be used in an embodiment to link multiple questions to a single challenge.

In another embodiment, a Question table contains a QuestionID field (used, for example, by the ChallengeToQuestion table to link challenges and questions) and a QuestionType field. The QuestionType may specify the type of question (also informing the type of answer), such as true or false, multiple choice, fill in the blank, multi-answer (e.g., with radio buttons), free text response, or media upload.

I/O module 850 may include one or more components configured to communicate information with a user associated with system 800. For example, I/O module 850 may include a console with an integrated keyboard and mouse to allow a user to input parameters associated with system 800, such as user passwords, names, and/or registration information. I/O module 250 may also include a display including a graphical user interface (GUI) for outputting information on a monitor, such as the screen of FIG. 9. I/O module 850 may also include peripheral devices such as, for example, a printer for printing information associated with system 800, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 860 may include one or more components configured to transmit and receive data via a communication network, such as the Internet, a local area network, a workstation peer-to-peer network, a direct link network, a wireless network, or any other suitable communication platform. For example, interface 860 may include one or more modulators, demodulators, multiplexers, demultiplexers, network communication devices, wireless devices, antennas, modems, and any other type of device configured to enable data communication via a communication network.

The system can also execute algorithms to keep the user engaged in the learn-do-inspire cycle. In one example, the system matches data from user activities to desired user activities to drive two types of responses. First, the system can notify users of a desired activity for completion by the user. The desired activity can be one that benefits the user or others within the enterprise. Second, the system can change an aspect of the environment, such as points or rewards, to drive the user to perform the activity. For example, the system can increase points for a quest to increase the probability that users perform the quest.

An algorithm for dynamically maintaining engagement can incorporate activity factors, such as an activity area, current user activity, desired user activity, environment modification, and activity confirmation status. The activity area can include To Do's, Inspiration, and Discussions. The current user activity can be measured based on activity level, activity frequency, and a timeframe that the user has interacted with the system. The desired user activity can include a desired level of activity, usage frequency, or usage timeframe.

Based on these activity factors, the system can notify the user of a specific activity for the user to complete. This can be a quest, an inspiration, message board participation, or a To-Do item. Then, based on whether the user performs the specific activity, the system can send further notifications. The notifications can continue to point the user to an activity that has not been performed yet. Alternatively, once the activity has been performed, the system can notify the user of a next activity based on the activity factors.

The system can use the activity factors to notify a user of due dates. For example, the user can be notified of a To-Do item that is due at a future date or time, and then notify the user if they miss the due date. The system can also deduct points from the user for missing the due date.

The system can also notify the user of discretionary activities, such as notifying a user that they have not been using the inspiration station enough. The system can detect that the user has not been inspiring enough. In response, it can encourage them to inspire another user.

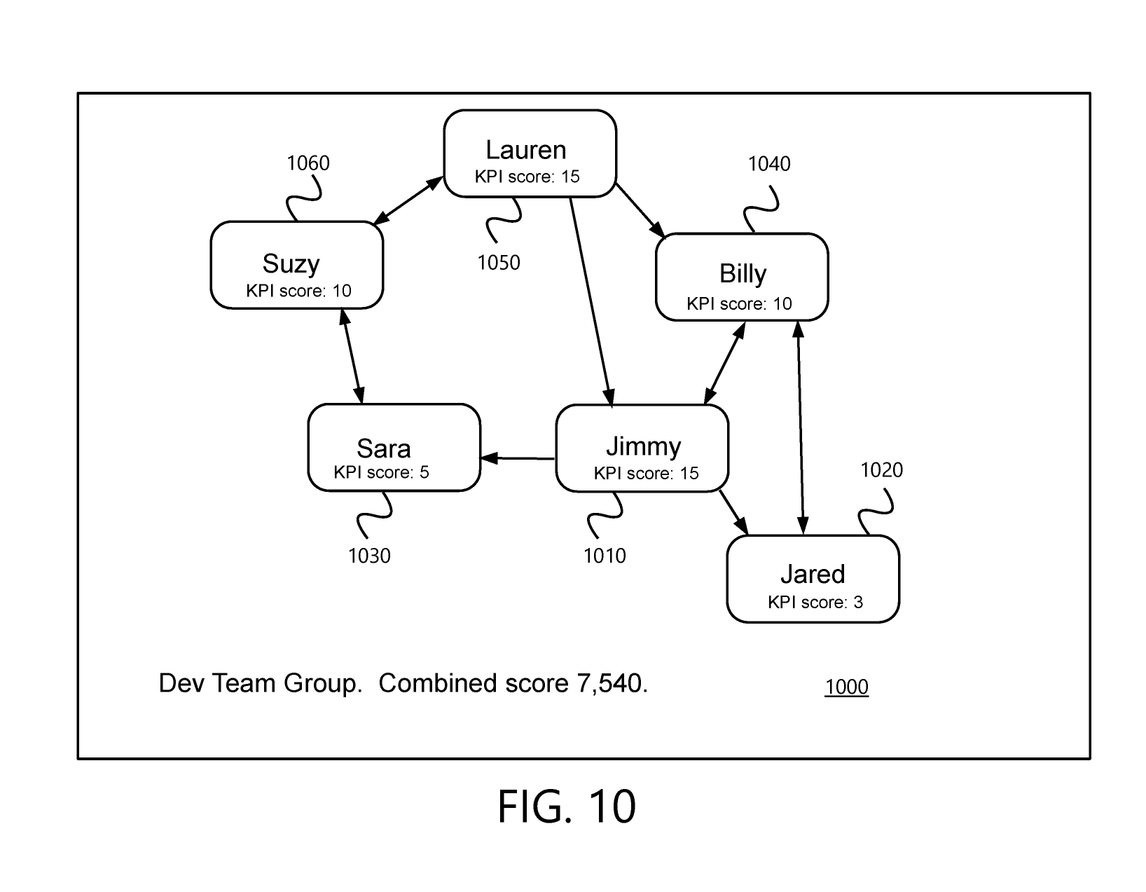

The system can also facilitate group learning. FIG. 10 illustrates an example administrator console GUI 1000 showing buddy links between users. The users can elect to friend each other.

In one example, the users can elect to inspire one another. Each inspiration can create a link between users. For example, Jimmy 1010 can inspire Billy 1040, Jared 1020, and Sara 1030. Lauren 1050 can inspire Jimmy 101. Billy 1040 and Jared 1020 can inspire each other. Suzy 1060 and Lauren 1050 can inspire each other, and so on.

In one example, an administrator can see an inspiration graph like the one show in FIG. 10. The inspiration graph can show which users are connected through inspiration within a group or between groups in an enterprise.

The graph can also help an administrator determine whether the enterprise training is helping the group performance. In the authoring suite, the administrator can connect To Do items to key performance indicators (“KPIs”). In the authoring suite, the administrator can drag a KPI into a To Do box, associating the KPI with the To Do. A KPI can include a measurable value that demonstrates how effectively a company is achieving key business objectives. KPIs can be used by an enterprise to evaluate their success at reaching targets.

Based on what people are doing, and administrator can see how the group is faring on KPIs. The KPIs can be counted and categorized based on the To Do items accomplished by individuals in the group. The To Do items are connected to the training materials. By analyzing how the enterprise is doing in the KPIs, and how much revenue the company has derived with respect to the KPIs, the administrator can determine how positively the training is impacting the company's bottom line. If the KPI values are increasing and the Do Items are being successfully completed, the training program is positively impacting KPIs. Whereas prior art training systems merely gauge effectiveness based on training attendance or, at most, a quiz, an example system can more directly link the training to KPIs and enterprise performance.

To help the administrator make this determination, the GUI can present a collective scoreboard for a group. The scoreboard can sum points within the group based on the learn-do-inspire framework. To compute points, the framework can take into account the KPI mapping to To Do items, the buddy system, user participation in forums, user content uploads, and the inspiration station data.

Users can improve because they are each inspiring each other, collaborating with each other, and working through similar quests and To Do items. This leads to them helping each other, and ultimately connecting to larger goals.

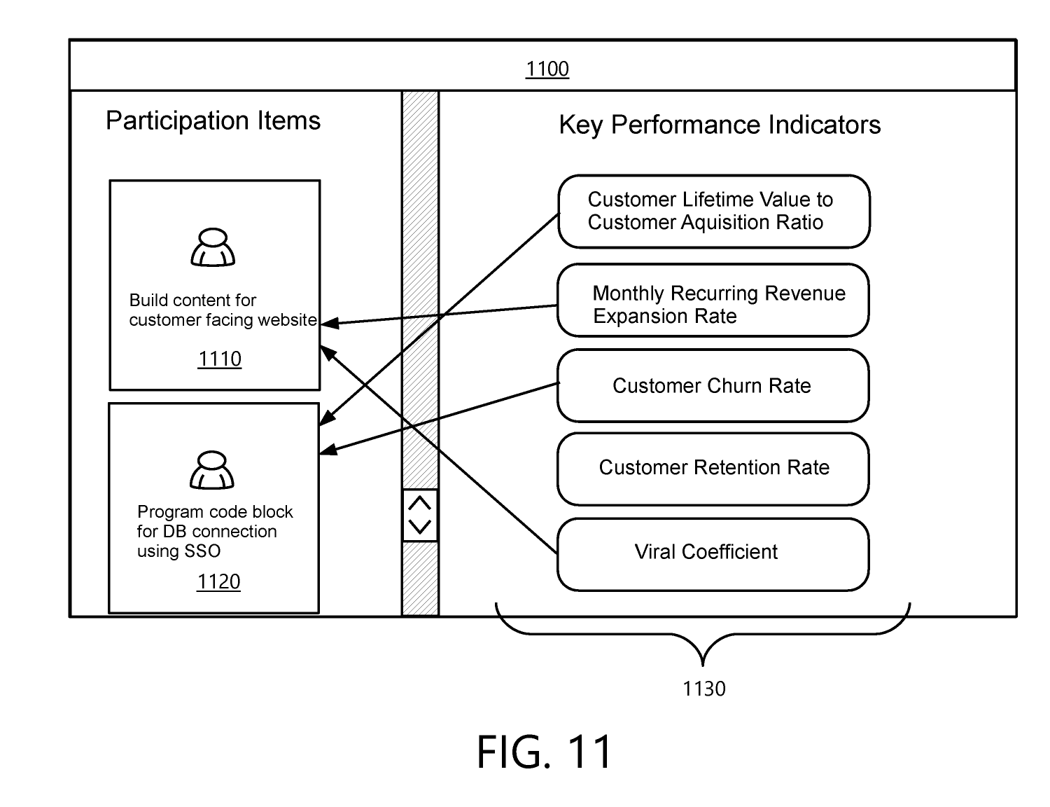

A GUI 1100 for associating KPIs to participation items (i.e., “Do Items” or “To Do Items”) is shown in FIG. 11. This GUI 1100 can be part of an authoring tool. The administrator can scroll through participation items and assign KPIs 1130 to those items. To do this, the administrator can drag the KPIs 1130 into the region 1110 and 1120 associated with the respective participation item.

In this example, the arrows illustrate the association made by the administrator by dragging KPIs 1130 into the participation item regions 1110 and 1120. The administrator has associated the first and third KPIs 1130 with the participation item associated with region 1120. The administrator has associated the second and fifth KPIs 1130 with the participation item associated with region 1110.

The administrator can associated these participation items with quests that are incorporated into a training environment (e.g., a program). When users perform the quests, they also must perform the participation items in order to fully complete the quest. Because the participation items are linked to KPIs, an administrator can gauge how effectively the quest is impacting KPIs by monitoring quest completion versus KPI increase. This allows an enterprise to continually optimize its learning environment in a way that directly impacts driving the KPIs needed for enterprise growth and profitability.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A learning system, including:
a database that includes content for a learning environment for use in an enterprise; and
a processor in communication with the database, the processor executing instructions to present a first user with a learning program having a hierarchy that includes:
at least a first level within the program;
at least a first quest within the first level, the first quest including:
media content that plays while a question is presented to the first user, wherein first scoring is associated with the user answering the question correctly; and
a first participation item for the user to perform within the enterprise, wherein a second user verifies that the first user performed the first participation item, wherein second scoring is associated with the first user completing the first participation item.

2. The learning system of claim 1, wherein the participation item requires performing a work task within the enterprise, the work task being associated with at least one key performance indicator by the processor.

3. The learning system of claim 1, wherein the processor further provides an administrator console graphical user interface that allows an administrator to drag a key performance indicator for association with the participation item, and the graphical user interface provides a group score based on the key performance indicator associated with the participation item.

4. The learning system of claim 1, wherein the second user verification is integrated with a scheduled employee review that is performed at least in part by the processor.

5. The learning system of claim 1, wherein the processor further receives authoring input from the first user, wherein the first user creates a second quest that is performed by a third user, wherein the third user performs a second participation item associated with the quest.

6. The learning system of claim 5, wherein the authoring input includes linking second content with a second question and the second participation item, and further includes linking a plurality of key performance indicators with the second participation item.

7. A learning system, including:
a first computing device;
a second computing device;
a server that communicates with the first and second computing devices, wherein the server provides a graphical user interphase for navigating a learning environment, the graphical user interface displaying on the first computing device and including:
simultaneous display of:
a program;
a plurality of levels within the program including first and second levels;
a plurality of quests within the first level including first and second quests that have at least first and second challenge and participation items, respectively; and
a score of a user of the first computing device, wherein the score is comprised of points from:
completing the at least one challenge;
completing the participation item; and
performing an inspiration activity with respect to a second user.

8. The learning system of claim 7, wherein the score of the user also includes points from a third quest created by the user and performed by a different user.

9. The learning system of claim 7, wherein the inspiration activity includes providing feedback regarding completion of a third participation item by the second user.

10. The learning system of claim 7, wherein a third quest is displayed with an indicator that the third quest is locked.

11. The learning system of claim 10, wherein the server will unlock the third quest by determining the score exceeds a threshold.

12. The learning system of claim 10, wherein the server organizes display of the first, second, and third quests based at least on profile attributes of the first user and completion statistics regarding the first, second, and third quests.

13. The learning system of claim 7, wherein the participation item requires performing a work task within the enterprise, the work task being associated with at least one key performance indicator by the server.

14. The learning system of claim 7, wherein the server further provides an administrator console graphical user interface that allows an administrator to drag a key performance indicator for association with the participation item, and the graphical user interface provides a group score based on the key performance indicator associated with the participation item, the group score representing a group that includes both the first and second user.

15. A learning authoring system, including:
a first computing device;
a second computing device;
a server in at least intermittent communication with the first and second computing devices, wherein a first user uses the first computing device to cause the server to perform stages to create a first quest, including:
create a challenge question;
associate a media file with the challenge question;
associate a participation item with the challenge question; and
set an unlock rule for the first quest;
wherein the server allows a second user to access the first quest with the second computing device based on the second user satisfying the unlock rule, wherein the access includes playing the media file while simultaneously displaying the challenge question.

16. The learning authoring system of claim 15, wherein the participation item requires performing a work task within the enterprise, the work task being associated with at least one key performance indicator by the server.

17. The learning authoring system of claim 15, wherein the server further provides a graphical user interface that allows an administrator to drag a key performance indicator into a region representing the participation item.

18. The learning authoring system of claim 17, wherein the graphical user interface provides a group score based at least in part on the key performance indicator associated with the participation item, the group score representing a group that includes both the first and second user.

19. The learning authoring system of claim 15, wherein the stages further include creating the participation item, wherein creating the participation item includes selecting a user type for verifying user participation.

20. The learning authoring system of claim 15, wherein the stages further include associating the quest with a program.
